(19) United States
(12) Patent Application Publication
(10) Pub. No.: US 2024/0107465 A1
(43) Pub. Date: Mar. 28, 2024

(54) MULTI-PANEL POWER HEADROOM REPORTING

(71) Applicant: QUALCOMM Incorporated, San Diego, CA (US)

(72) Inventors: Fang YUAN, Beijing (CN); Jelena DAMNJANOVIC, Del Mar, CA (US); Yan ZHOU, San Diego, CA (US); Mostafa KHOSHNEVISAN, San Diego, CA (US); Tao LUO, San Diego, CA (US); Juan MONTOJO, San Diego, CA (US)

(21) Appl. No.: 18/252,621

(22) PCT Filed: Jan. 15, 2021
(86) PCT No.: PCT/CN2021/072008

§ 371 Date: May 11, 2023

(51) Int. Cl. H04W 52/36; H04W 52/24

(52) U.S. Cl. CPC H04W 52/365; H04W 52/242; H04W 52/367; H04W 80/02

(57) ABSTRACT

Various aspects of the present disclosure generally relate to wireless communication. In some aspects, a user equipment (UE) may generate a medium access control control element (MAC-CE) that indicates a power headroom level for each panel of multiple panels of the UE, which is configured for multi-panel operation. The UE may transmit the MAC-CE. Numerous other aspects are described.

### FIELD OF THE DISCLOSURE

Aspects of the present disclosure generally relate to wireless communication and to techniques and apparatuses for reporting power headroom for multiple panels.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes generating a medium access control control element (MAC-CE) that indicates a power headroom level for each panel of multiple panels of the UE, which is configured for multi-panel operation, and transmitting the MAC-CE.

In some aspects, a method of wireless communication performed by a base station includes transmitting, to a UE, a configuration for multi-panel power headroom level reporting, and receiving a MAC-CE that indicates a power headroom level for each panel of multiple panels of the UE based at least in part on the configuration.

In some aspects, a method of wireless communication performed by a UE includes generating a MAC-CE that indicates a power headroom level for a single panel among multiple panels of the UE, which is configured for multi-panel operation, based at least in part on a value of a multi-panel indication of a radio resource control parameter being set to indicate single-panel entries for the MAC-CE, and transmitting the MAC-CE.

In some aspects, a method of wireless communication performed by a base station includes transmitting, to a UE, an indication that a configuration of the UE for multi-panel reporting of power headroom levels is to be used to report a single panel among multiple panels of the UE, and receiving a MAC-CE that indicates a power headroom level for the single panel, based at least in part on the indication.

In some aspects, a UE for wireless communication includes a memory and one or more processors operatively coupled to the memory, the memory and the one or more processors configured to generate a MAC-CE that indicates a power headroom level for each panel of multiple panels of the UE, which is configured for multi-panel operation, and transmit the MAC-CE.

In some aspects, a base station for wireless communication includes a memory and one or more processors operatively coupled to the memory, the memory and the one or more processors configured to transmit, to a UE, a configuration for multi-panel power headroom level reporting, and receive a MAC-CE that indicates a power headroom level for each panel of multiple panels of the UE based at least in part on the configuration.

In some aspects, a UE for wireless communication includes a memory and one or more processors operatively coupled to the memory, the memory and the one or more processors configured to generate a MAC-CE that indicates a power headroom level for a single panel among multiple panels of the UE, which is configured for multi-panel operation, based at least in part on a value of a multi-panel indication of a radio resource control parameter being set to indicate single-panel entries for the MAC-CE, and transmit the MAC-CE.

In some aspects, a base station for wireless communication includes a memory and one or more processors operatively coupled to the memory, the memory and the one or more processors configured to transmit, to a UE, an indication that a configuration of the UE for multi-panel reporting of power headroom levels is to be used to report a single panel among multiple panels of the UE, and receive a MAC-CE that indicates a power headroom level for the single panel, based at least in part on the indication.

In some aspects, a non-transitory computer-readable medium storing a set of instructions for wireless communication includes one or more instructions that, when executed by one or more processors of a UE, cause the UE to generate a MAC-CE that indicates a power headroom level for each panel of multiple panels of the UE, which is configured for multi-panel operation, and transmit the MAC-CE.

In some aspects, a non-transitory computer-readable medium storing a set of instructions for wireless communication includes one or more instructions that, when executed by one or more processors of a base station, cause the base station to transmit, to a UE, a configuration for multi-panel power headroom level reporting, and receive a MAC-CE that indicates a power headroom level for each panel of multiple panels of the UE based at least in part on the configuration.

In some aspects, a non-transitory computer-readable medium storing a set of instructions for wireless communication includes one or more instructions that, when executed by one or more processors of a UE, cause the UE to generate a MAC-CE that indicates a power headroom level for a single panel among multiple panels of the UE, which is configured for multi-panel operation, based at least in part on a value of a multi-panel indication of a radio resource control parameter being set to indicate single-panel entries for the MAC-CE, and transmit the MAC-CE.

In some aspects, a non-transitory computer-readable medium storing a set of instructions for wireless communication includes one or more instructions that, when executed by one or more processors of a base station, cause the base station to transmit, to a UE, an indication that a configuration of the UE for multi-panel reporting of power headroom levels is to be used to report a single panel among multiple panels of the UE, and receive a MAC-CE that indicates a power headroom level for the single panel, based at least in part on the indication.

In some aspects, an apparatus for wireless communication includes means for generating a MAC-CE that indicates a power headroom level for each panel of multiple panels of the apparatus, which is configured for multi-panel operation, and means for transmitting the MAC-CE.

In some aspects, an apparatus for wireless communication includes means for transmitting, to a UE, a configuration for multi-panel power headroom level reporting, and means for receiving a MAC-CE that indicates a power headroom level for each panel of multiple panels of the UE based at least in part on the configuration.

In some aspects, an apparatus for wireless communication includes means for generating a MAC-CE that indicates a power headroom level for a single panel among multiple panels of the apparatus, which is configured for multi-panel operation, based at least in part on a value of a multi-panel indication of a radio resource control parameter being set to indicate single-panel entries for the MAC-CE, and means for transmitting the MAC-CE.

In some aspects, an apparatus for wireless communication includes means for transmitting, to a UE, an indication that a configuration of the UE for multi-panel reporting of power headroom levels is to be used to report a single panel among multiple panels of the UE, and means for receiving a MAC-CE that indicates a power headroom level for the single panel, based at least in part on the indication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a user equipment (UE) in a wireless network, in accordance with various aspects of the present disclosure.

FIG. 3 is a diagram illustrating an example of a power headroom report for a single panel, in accordance with various aspects of the present disclosure.

FIG. 4 is a diagram illustrating an example of a power headroom report for multiple panels, in accordance with various aspects of the present disclosure.

FIG. 5 is a diagram illustrating an example of reporting power headroom for multiple panels, in accordance with various aspects of the present disclosure.

FIG. 6 is a diagram illustrating an example of multi-cell reporting for multiple panels, in accordance with various aspects of the present disclosure.

FIG. 7 is a diagram illustrating an example process performed, for example, by a UE, in accordance with various aspects of the present disclosure.

FIG. 8 is a diagram illustrating an example process performed, for example, by a base station, in accordance with various aspects of the present disclosure.

FIG. 9 is a diagram illustrating an example process performed, for example, by a UE, in accordance with various aspects of the present disclosure.

FIG. 10 is a diagram illustrating an example process performed, for example, by a base station, in accordance with various aspects of the present disclosure.

FIGS. 11-14 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

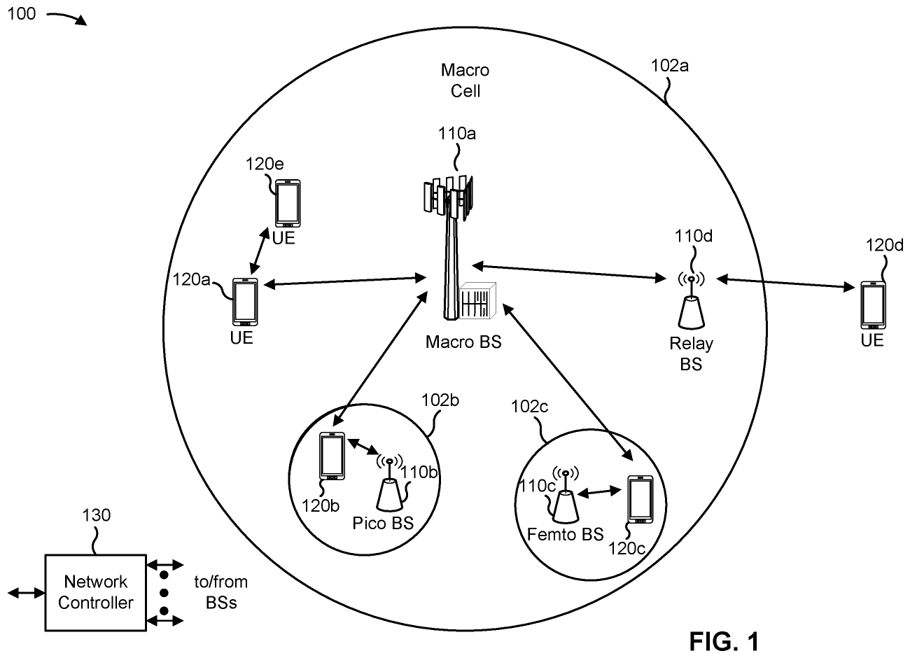

FIG. 1 is a diagram illustrating an example of a wireless network 100, in accordance with various aspects of the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

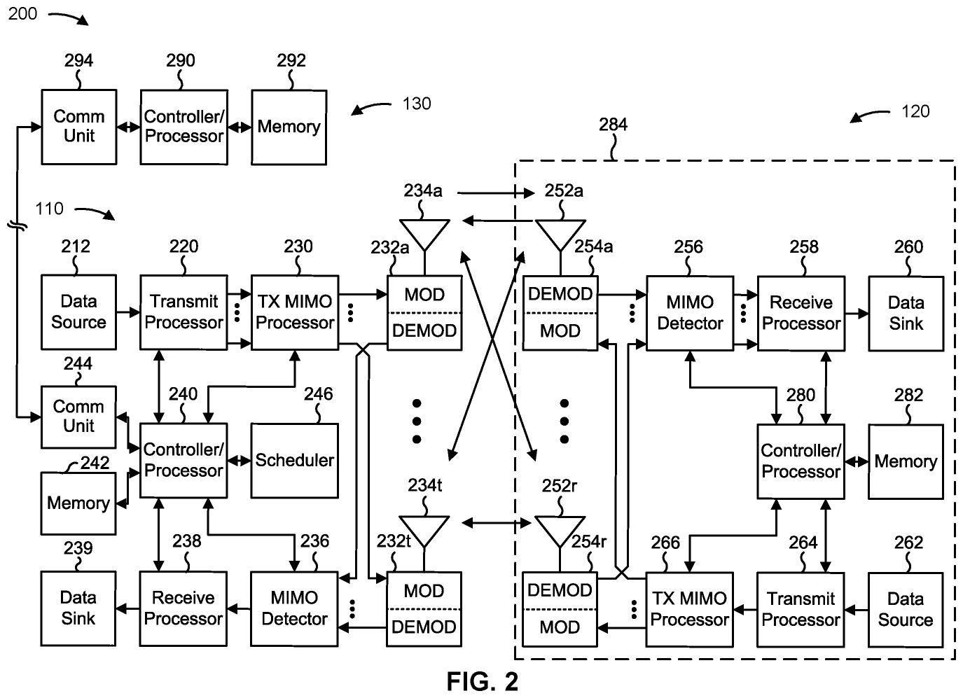

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 1-14.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 1-14.

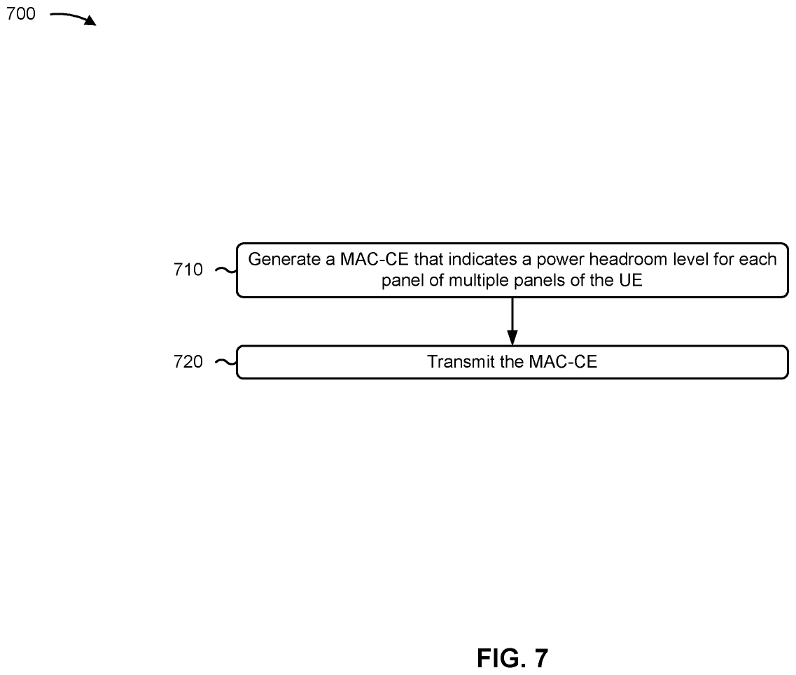

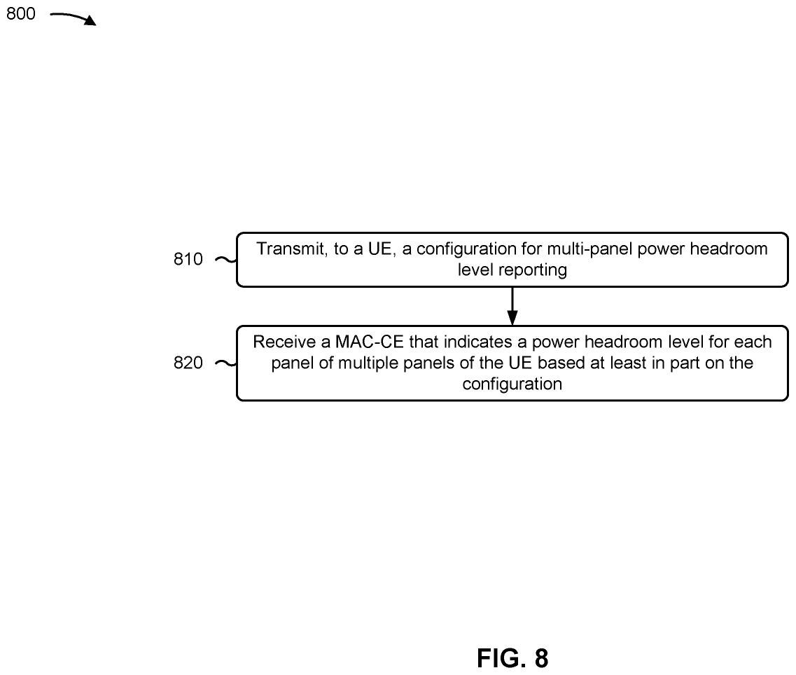

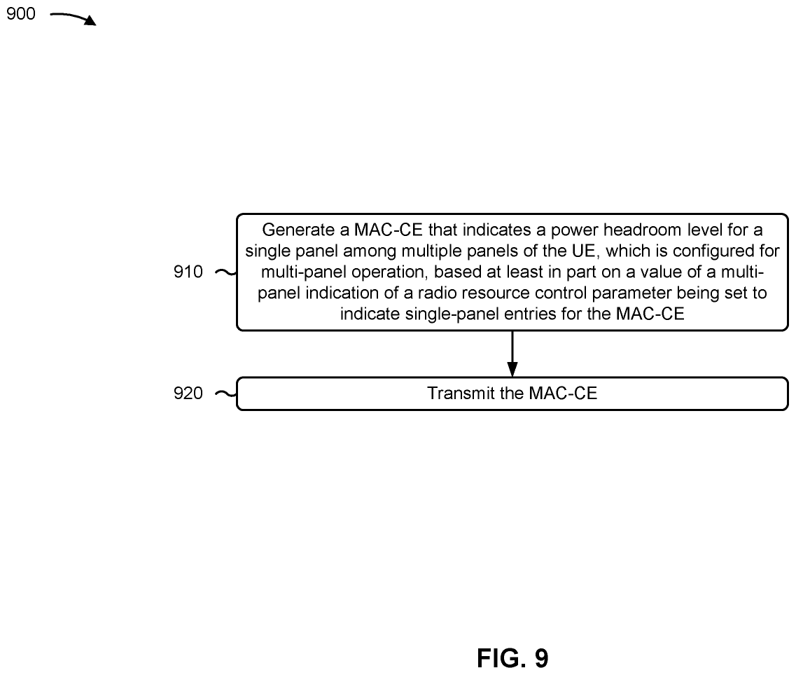

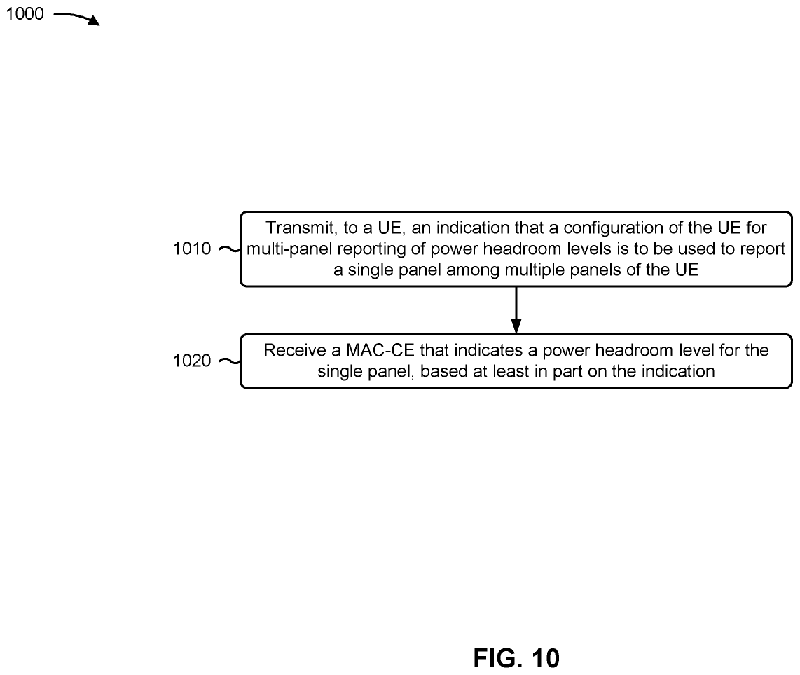

Controller/processor 240 of base station 110, controller/processor 280 of UE 120, and/or any other component(s) of FIG. 2 may perform one or more techniques associated with reporting power headroom for multiple panels, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, process 1000 of FIG. 10, and/or other processes as described herein. In some aspects, executing instructions may include running the instructions, converting the instructions, compiling the instructions, and/or interpreting the instructions, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

In some aspects, UE 120 includes means for generating a medium access control control element (MAC-CE) that indicates a power headroom level for each panel of multiple panels of the UE, which is configured for multi-panel operation, and/or means for transmitting the MAC-CE. The means for UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, UE 120 includes means for selecting the one or more cells and the one or more activated panels.

In some aspects, base station 110 includes means for transmitting, to a UE, a configuration for multi-panel power headroom level reporting, and/or means for receiving a MAC-CE that indicates a power headroom level for each panel of multiple panels of the UE based at least in part on the configuration. The means for base station 110 to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, base station 110 includes means for transmitting, to the UE, an indication to adjust a transmit power or a schedule of an uplink communication of the UE based at least in part on one or more power headroom level values in the MAC-CE.

In some aspects, the base station includes means for transmitting an indication of the one or more cells and the one or more activated panels to be included in the MAC-CE.

In some aspects, UE 120 includes means for generating a MAC-CE that indicates a power headroom level for a single panel among multiple panels of the UE, which is configured for multi-panel operation, based at least in part on a value of a multi-panel indication of a radio resource control parameter being set to indicate single-panel entries for the MAC-CE, and/or means for transmitting the MAC-CE. The means for UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, base station 110 includes means for transmitting, to a UE, an indication that a configuration of the UE for multi-panel reporting of power headroom levels is to be used to report a single panel among multiple panels of the UE, and/or means for receiving a MAC-CE that indicates a power headroom level for the single panel, based at least in part on the indication. The means for base station 110 to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, base station 110 includes means for transmitting, to the UE, an indication to adjust a transmit power or a schedule of an uplink communication of the UE based at least in part on a power headroom level value in the MAC-CE.

In some aspects, base station 110 includes means for transmitting a value for a triggering condition that includes a threshold for one or more of panel-specific path loss or a maximum permitted exposure level.

As indicated above, FIG. 2 is provided as an example. Other examples may differ from what is described with regard to FIG. 2.

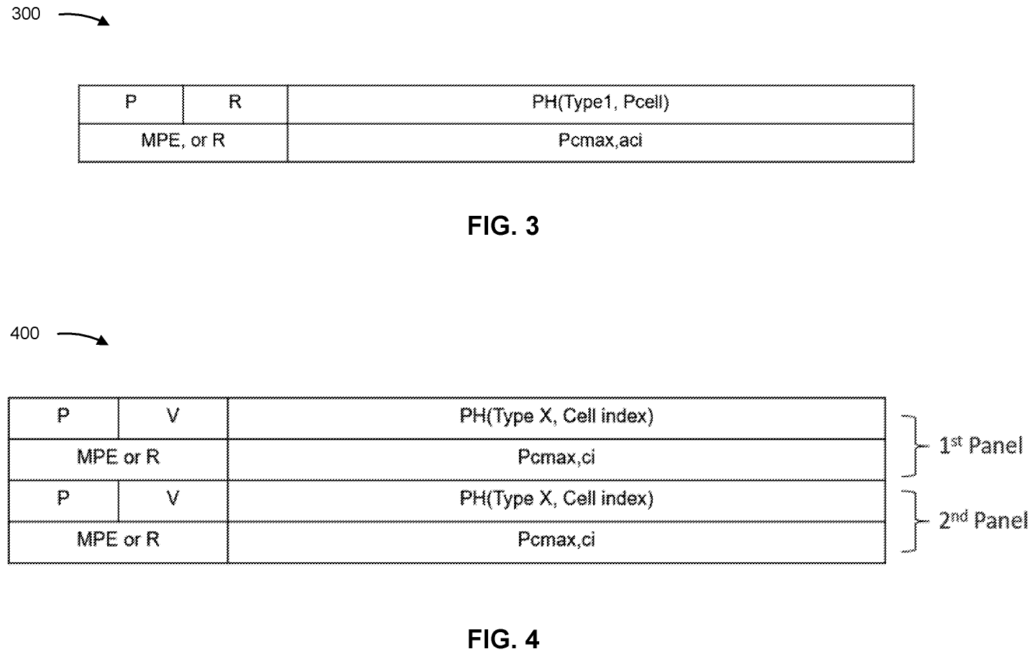

FIG. 3 is a diagram illustrating an example 300 of a power headroom report for a single panel, in accordance with various aspects of the present disclosure.

A UE may transmit communications in an uplink beam with a certain amount of transmit power. This transmit power may be limited due to a maximum permissible exposure (MPE) constraint (e.g., an MPE limitation, an MPE restriction), such as an MPE-based maximum power limit. The UE may limit the transmit power to an MPE-constrained maximum transmit power for an uplink beam based at least in part on an effective isotropic radiated power (EIRP) value for the uplink beam, a maximum or peak EIRP value stored by the UE (e.g., as dictated by a governing body, as specified in a wireless communication standard), or a determination of whether the uplink beam is directed toward a body (e.g., a human body). If the uplink beam is directed toward a body, then the UE may set the MPE-constrained maximum transmit power based at least in part on a determined EIRP value for the uplink beam and/or a maximum permitted EIRP value. If the uplink beam is not directed toward a body, then the UE may set the MPE-constrained maximum transmit power to a maximum transmit power value for the UE.

An amount of transmit power that a UE is able to use in addition to a current transmit power and up to an MPE-based maximum power limit may be referred to as “power headroom.” A UE may be able to indicate a level of power headroom available to the UE in a power headroom report (PHR). The UE may provide the PHR in a MAC-CE. The network may use the PHR to estimate how much uplink bandwidth a UE can use for a specific subframe. The more power headroom that is available, the more bandwidth the UE can use. Power headroom levels may range from −23 decibels (dB) to more than 40 dB. A path loss change or a timer may trigger transmission of a PHR.

The MAC-CE used for a PHR may include an entry indicating a power headroom (PH) value for a single panel for a single serving cell, such as shown by example 300. The entry may indicate a type, such as Type 1 for a physical uplink shared channel (PUSCH) or Type 3 for a sounding reference signal (SRS). The entry may identify the serving cell. An entry may indicate a power (P_{CMAX, f, c}) used for calculation of a preceding PH field. A P field relates to power backoff and an MPE field indicates whether an applied power backoff meets MPE requirements. Some MAC-CEs may provide a PHR for multiple cells, where entries may include a serving cell index (Ci) field and a virtual field (V) that indicates whether a power headroom value is virtual (PUSCH transmission not scheduled) or real (PUSCH transmission scheduled).

A UE with multiple antenna panels may be configured for multi-panel operation. However, the UE provides a MAC-CE with a PHR for a single panel. To provide PHRs for the multiple panels, the UE generates and transmits multiple MAC-CEs, which consumes process resources and signaling resources.

As indicated above, FIG. 3 is provided as an example. Other examples may differ from what is described with regard to FIG. 3.

FIG. 4 is a diagram illustrating an example 400 of a power headroom report for multiple panels, in accordance with various aspects of the present disclosure.

According to various aspects described herein, a UE may be configured to provide a PHR for multiple panels in a single MAC-CE. The MAC-CE may include panel-specific entries for each of multiple panels. Example 400 shows a MAC-CE with panel-specific power headroom levels for multiple panels. The PHR may also indicate MPE information (MPE field) for each panel and indicate whether a power headroom level is virtual or real (V field). A MAC-CE may include at least one PHR entry that is real. By providing a panel-specific PHR for multiple panels in a single MAC-CE, the UE and the network conserve processing resources and signaling resources.

In some aspects, the UE may generate and transmit the multi-panel PHR based at least in part on a radio resource control (RRC) parameter (e.g., multi-panel-PHR) being set to “true.” The PHR may be for activated panels of a serving cell with configured uplink associated with a medium access control (MAC) entity. The MAC entity (or another MAC entity) may have uplink resources allocated for transmission on reported panels of the serving cell. The UE may obtain a value of a Type 1 or Type 3 power headroom for a corresponding panel of an uplink carrier. The UE may obtain a value for the P_{CMAX, f, c} field.

For example, a UE may generate the multi-panel PHR based at least in part on the following. If the power headroom reporting procedure determines that at least one PHR has been triggered and not cancelled, and if the allocated uplink resources can accommodate the MAC-CE for PHR which the MAC entity is configured to transmit, plus its subheader, as a result of logical channel prioritization; if multiple-panel PHR is configured and with value of “true”, for each activated panel of the serving cell with configured uplink associated with any MAC entity, obtain the value of the Type 1 or Type 3 power headroom for the corresponding panel of uplink carrier. If this MAC entity has uplink resources allocated for transmission on this panel of the serving cell, or if the other MAC entity, if configured, has uplink resources allocated for transmission on this panel of the serving cell and phr-ModeOtherCG is set to real by upper layers, obtain the value for the corresponding P_{CMAX,f,c} field from the physical layer.

In some aspects, the MAC-CE may order the entries for the panels based at least in part on one or more factors, such as an activated panel identifier (ID), an SRS resource ID for an SRS resource set used for antenna switching, a codebook, a non-codebook uplink MIMO transmission, a control resource set pool ID, a closed loop index in power control, a beam group ID, and/or a transmission configuration indicator pool ID.

As indicated above, FIG. 4 is provided as an example. Other examples may differ from what is described with regard to FIG. 4.

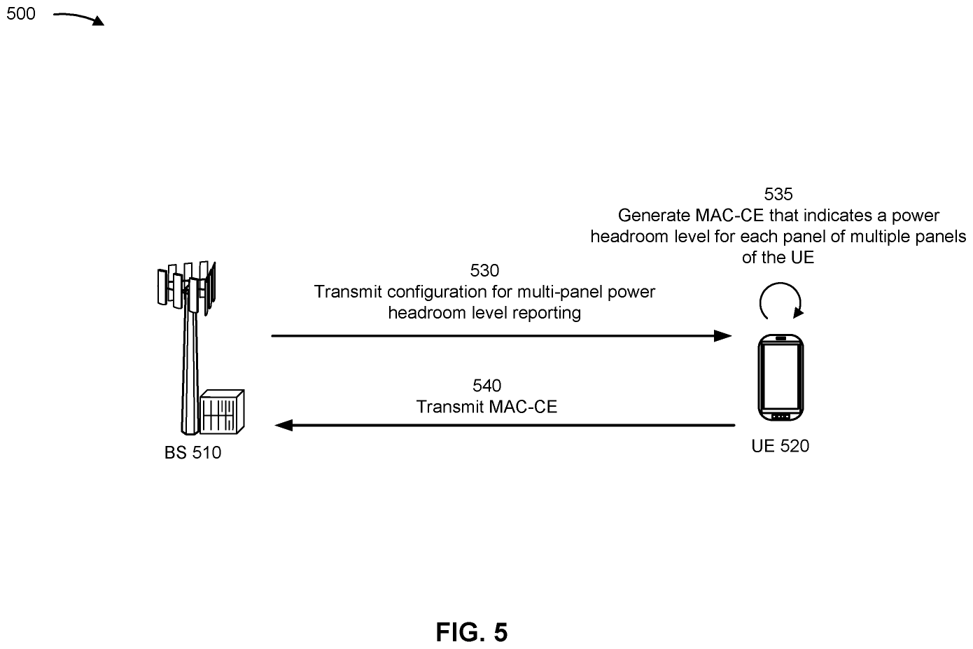

FIG. 5 is a diagram illustrating an example 500 of reporting power headroom for multiple panels, in accordance with various aspects of the present disclosure. As shown, FIG. 5 includes a base station (BS) 510 (e.g., base station 110) and a UE 520 that may communicate with each other over a connection that is wireless or wired. The connection may include an uplink or a downlink.

As shown by reference number 530, BS 510 may transmit a configuration for multi-panel power headroom reporting. The configuration may specify that UE 520 is to provide a multi-panel PHR. The configuration may specify entries for the PHR and/or an order of the entries. The configuration may be specified by one or more RRC parameters.

As shown by reference number 535, UE 520 may generate a MAC-CE that indicates, among other information, a power headroom level for each panel of multiple panels of UE 520. The MAC-CE may include fields as described in connection with FIG. 4. As shown by reference number 540, UE 520 may transmit the MAC-CE. By indicating power headroom levels for multiple panels in the same MAC-CE, the UE conserves processing resources and signaling resources.

In some aspects, UE 520 may be configured with multiple PUSCH repetitions for a transport block during multi-panel operation. The repetitions may be in a frequency domain, a spatial domain, or a time domain. UE 520 may transmit the same panel-specific PHR in each PUSCH repetition. The PHR may be based at least in part on uplink resources allocated for corresponding panels. In some aspects involving frequency division multiplexing repetitions, UE 520 may use only a part of a frequency domain resource allocation (e.g., bandwidth) to calculate the PHR for each panel. This may save processing resources. For PHRs transmitted in PUSCH repetitions, the PHR may be real, and the V field may be reserved for other uses.

In some aspects, although UE 520 is configured for multi-panel PHR reporting, UE 520 may receive an indication from BS 510 that UE 520 is to report PHR for a single panel. For example, a multi-panel-PHR parameter may be set to “false”. An X field may be used to indicate whether the PHR for the single panel is real or virtual. For example, if X is set to “0”, the PHR is real and the PHR type may be Type 1. If X is set to “1”, the PHR is virtual and the PHR type may be Type 1 or Type 3. Additional octets of the MAC-CE may indicate a panel ID if there is more than one panel for UE 520.

In some aspects, the PHR is reported based at least in part on a reporting condition. If the reporting condition is satisfied, UE 520 may proceed with PHR reporting for the panel (e.g., a panel-specific path loss change, a MPE value change, or a PH value change is large than a threshold). If two panels satisfy the reporting condition, UE 520 may prioritize a real PHR over a virtual PHR.

As indicated above, FIG. 5 is provided as an example. Other examples may differ from what is described with regard to FIG. 5.

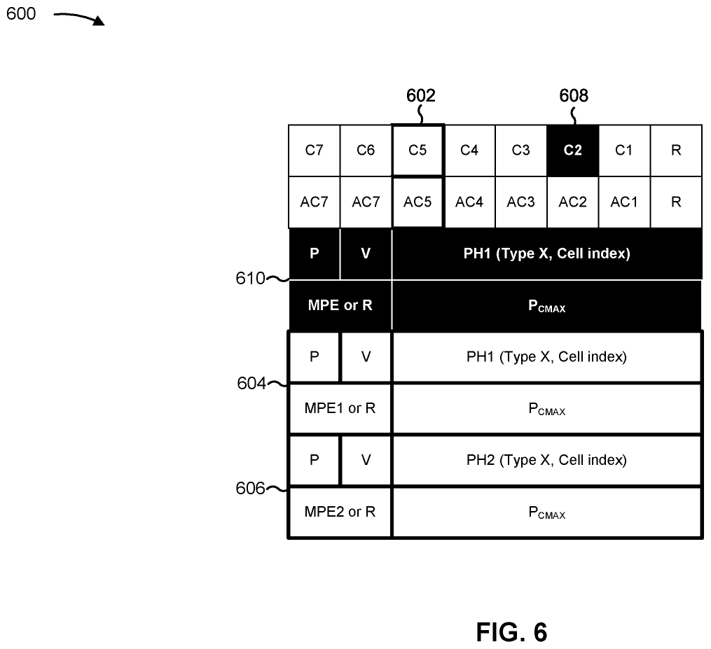

FIG. 6 is a diagram illustrating an example 600 of multi-cell reporting for multiple panels, in accordance with various aspects of the present disclosure.

A UE may be configured to transmit a PHR report in a single MAC-CE for multiple panels and multiple cells. Example 600 shows panel entries that are specified per cell. For example, cell information 602 corresponds to panel 1 entries 604 and panel 2 entries 606. The “C5” may correspond to panel entries 604, and the “AC5” may correspond to panel 2 entries 606. Cell information 608 corresponds to panel entry 610. The activated panels may be indicated by the network (e.g., gNB). If the gNB activates 2 of 4 UE panels for a cell, the UE may report a PHR for the 2 activated panels.

In some aspects, the UE may select the panels for the PHR. The process for generating the multi-panel PHR, as described in connection with FIG. 4, may be modified such that values are obtained for each activated and determined to be reported panel of the serving cell with configured uplink associated with any MAC entity. In some aspects, the UE may determine to indicate only panels with larger MPE issues or alternative panels to the MPE issue panels. The UE may indicate the panel ID. The UE may transmit a PHR for only the panels that the UE determined to report. In this way, the UE may conserve processing resources and signaling resources.

As indicated above, FIG. 6 is provided as an example. Other examples may differ from what is described with regard to FIG. 6.

FIG. 7 is a diagram illustrating an example process 700 performed, for example, by a UE, in accordance with various aspects of the present disclosure. Example process 700 is an example where the UE (e.g., UE 120 depicted in FIGS. 1-2, UE 520 depicted in FIG. 5) performs operations associated with multi-panel power headroom reporting.

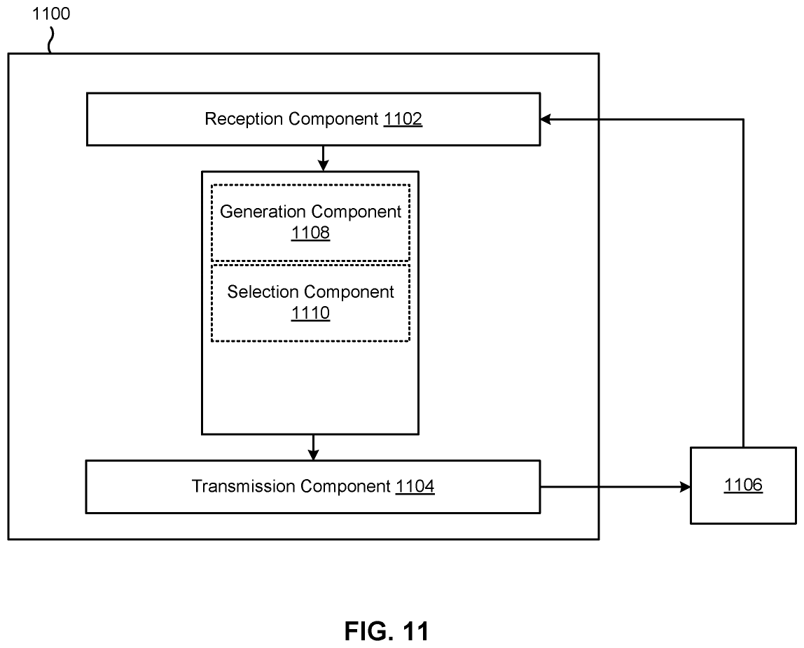

As shown in FIG. 7, in some aspects, process 700 may include generating a MAC-CE that indicates a power headroom level for each panel of multiple panels of the UE, which is configured for multi-panel operation (block 710). For example, the UE (e.g., using generation component 1108 depicted in FIG. 11) may generate a MAC-CE that indicates a power headroom level for each panel of multiple panels of the UE, which is configured for multi-panel operation, as described above.

As further shown in FIG. 7, in some aspects, process 700 may include transmitting the MAC-CE (block 720). For example, the UE (e.g., using transmission component 1104 depicted in FIG. 11) may transmit the MAC-CE, as described above.

Process 700 may include additional aspects, such as any single aspect or any combination of aspects described below and/or in connection with one or more other processes described elsewhere herein.

In a first aspect, the MAC-CE indicates whether the power headroom level for each panel is for a real panel or a virtual panel.

In a second aspect, alone or in combination with the first aspect, an order of entries for the multiple panels in the MAC-CE is based at least in part on one or more of a panel ID, an SRS resource ID, an SRS resource set, a control resource set pool ID, a closed loop index, a beam group ID, or a transmission configuration indicator state pool ID.

In a third aspect, alone or in combination with one or more of the first and second aspects, the generating of the MAC-CE for multiple panels is based at least in part on a value of a multi-panel indication of an RRC parameter indicating multi-panel entries for the MAC-CE.

In a fourth aspect, alone or in combination with one or more of the first through third aspects, the MAC-CE indicates power headroom levels for a single cell.

In a fifth aspect, alone or in combination with one or more of the first through fourth aspects, the MAC-CE indicates a type of signal or a type of channel for the power headroom level.

In a sixth aspect, alone or in combination with one or more of the first through fifth aspects, the MAC-CE corresponds to each repetition of a same transport block.

In a seventh aspect, alone or in combination with one or more of the first through sixth aspects, the MAC-CE indicates power headroom levels for multiple cells and indicates one or more cells and one or more activated panels for which the power headroom levels in the MAC-CE apply.

In an eighth aspect, alone or in combination with one or more of the first through seventh aspects, the one or more cells and the one or more activated panels are indicated by a base station.

In a ninth aspect, alone or in combination with one or more of the first through eighth aspects, process 700 includes selecting the one or more cells and the one or more activated panels.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with various aspects of the present disclosure. Example process 800 is an example where the base station (e.g., base station 110 depicted in FIGS. 1-2, BS 510 depicted in FIG. 5) performs operations associated with multi-panel power headroom reporting.

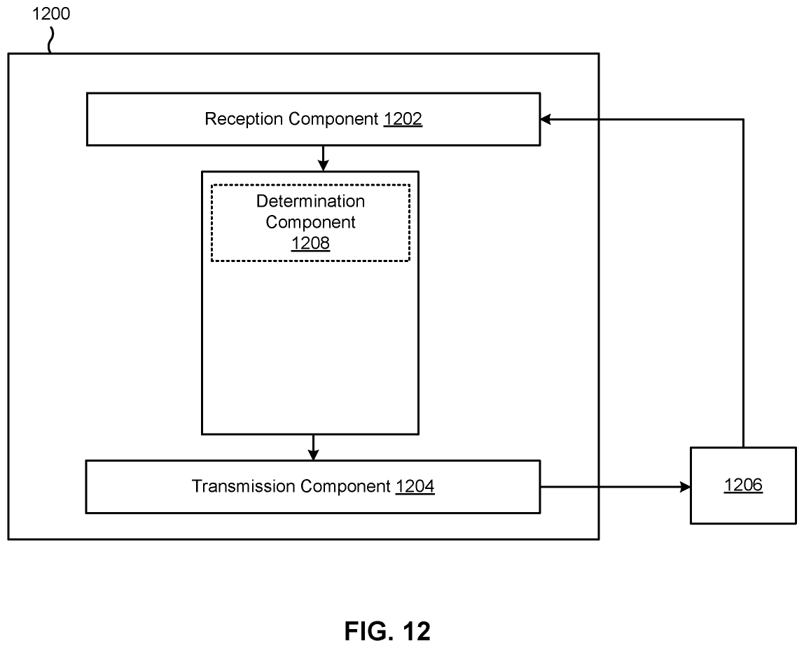

As shown in FIG. 8, in some aspects, process 800 may include transmitting, to a UE, a configuration for multi-panel power headroom level reporting (block 810). For example, the base station (e.g., using transmission component 1204 depicted in FIG. 12) may transmit, to a UE, a configuration for multi-panel power headroom level reporting, as described above.

As further shown in FIG. 8, in some aspects, process 800 may include receiving a MAC-CE that indicates a power headroom level for each panel of multiple panels of the UE based at least in part on the configuration (block 820). For example, the base station (e.g., using reception component 1202 depicted in FIG. 12) may receive a MAC-CE that indicates a power headroom level for each panel of multiple panels of the UE based at least in part on the configuration, as described above.

Process 800 may include additional aspects, such as any single aspect or any combination of aspects described below and/or in connection with one or more other processes described elsewhere herein.

In a first aspect, process 800 includes transmitting, to the UE, an indication to adjust a transmit power or a schedule of an uplink communication of the UE based at least in part on one or more power headroom level values in the MAC-CE.

In a second aspect, alone or in combination with the first aspect, the MAC-CE indicates whether the power headroom level for each panel is for a real panel or a virtual panel.

In a third aspect, alone or in combination with one or more of the first and second aspects, an order of entries for the multiple panels in the MAC-CE is based at least in part on one or more of a panel ID, an SRS resource ID, an SRS resource set, a control resource set pool ID, a closed loop index, a beam group ID, or a transmission configuration indicator state pool ID.

In a fourth aspect, alone or in combination with one or more of the first through third aspects, the MAC-CE indicates power headroom levels for a single cell.

In a fifth aspect, alone or in combination with one or more of the first through fourth aspects, the MAC-CE indicates a type of signal or a type of channel for the power headroom level.

In a sixth aspect, alone or in combination with one or more of the first through fifth aspects, the MAC-CE corresponds to each repetition of a same transport block.

In a seventh aspect, alone or in combination with one or more of the first through sixth aspects, the MAC-CE indicates power headroom levels for multiple cells and indicates one or more cells and one or more activated panels for which power headroom levels in the MAC-CE apply.

In an eighth aspect, alone or in combination with one or more of the first through seventh aspects, process 800 includes transmitting an indication of the one or more cells and the one or more activated panels to be included in the MAC-CE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with various aspects of the present disclosure. Example process 900 is an example where the UE (e.g., UE 120 depicted in FIGS. 1-2, UE 520 depicted in FIG. 5) performs operations associated with multi-panel power headroom reporting.

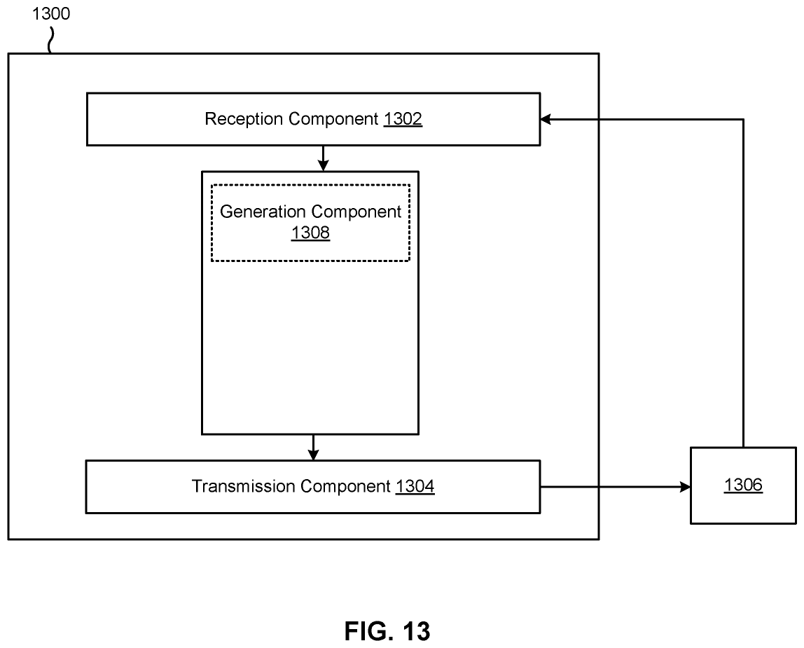

As shown in FIG. 9, in some aspects, process 900 may include generating a MAC-CE that indicates a power headroom level for a single panel among multiple panels of the UE, which is configured for multi-panel operation, based at least in part on a value of a multi-panel indication of a radio resource control parameter being set to indicate single-panel entries for the MAC-CE (block 910). For example, the UE (e.g., using generation component 1308 depicted in FIG. 13) may generate a MAC-CE that indicates a power headroom level for a single panel among multiple panels of the UE, which is configured for multi-panel operation, based at least in part on a value of a multi-panel indication of a radio resource control parameter being set to indicate single-panel entries for the MAC-CE, as described above.

As further shown in FIG. 9, in some aspects, process 900 may include transmitting the MAC-CE (block 920). For example, the UE (e.g., using transmission component 1304 depicted in FIG. 13) may transmit the MAC-CE, as described above.

Process 900 may include additional aspects, such as any single aspect or any combination of aspects described below and/or in connection with one or more other processes described elsewhere herein.

In a first aspect, the MAC-CE indicates whether the power headroom level for each panel is for a real panel or a virtual panel.

In a second aspect, alone or in combination with the first aspect, the generating of the MAC-CE for multiple panels is based at least in part on satisfaction of a triggering condition that includes one or more of panel-specific path loss or a change in an MPE level.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with various aspects of the present disclosure. Example process 1000 is an example where the base station (e.g., base station 110 depicted in FIGS. 1-2, BS 510 depicted in FIG. 5) performs operations associated with multi-panel power headroom reporting.

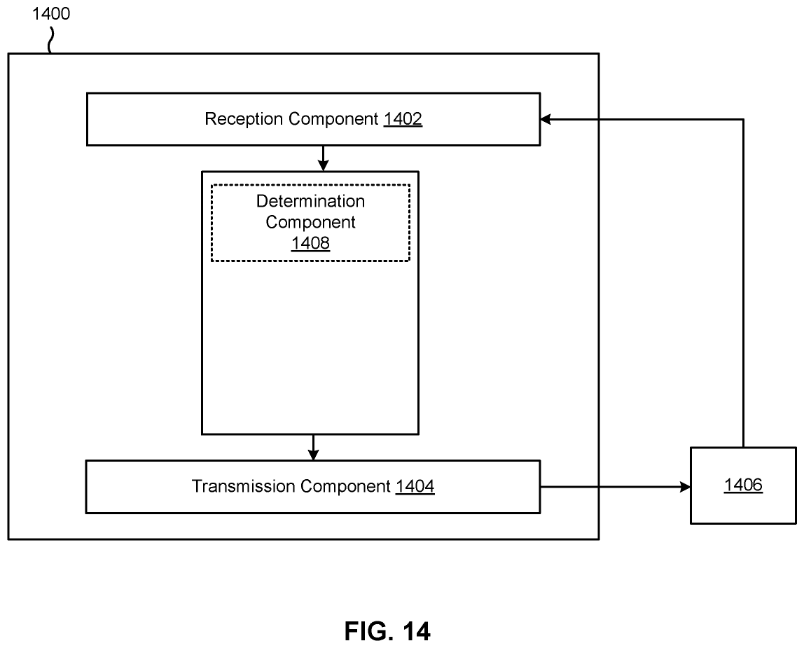

As shown in FIG. 10, in some aspects, process 1000 may include transmitting, to a UE, an indication that a configuration of the UE for multi-panel reporting of power headroom levels is to be used to report a single panel among multiple panels of the UE (block 1010). For example, the base station (e.g., using transmission component 1404 depicted in FIG. 14) may transmit, to a UE, an indication that a configuration of the UE for multi-panel reporting of power headroom levels is to be used to report a single panel among multiple panels of the UE, as described above.

As further shown in FIG. 10, in some aspects, process 1000 may include receiving a MAC-CE that indicates a power headroom level for the single panel, based at least in part on the indication (block 1020). For example, the base station (e.g., using reception component 1402 depicted in FIG. 14) may receive a MAC-CE that indicates a power headroom level for the single panel, based at least in part on the indication, as described above.

Process 1000 may include additional aspects, such as any single aspect or any combination of aspects described below and/or in connection with one or more other processes described elsewhere herein.

In a first aspect, the indication includes a value of a multi-panel indication of a radio resource control parameter that is set to indicate single-panel entries for the MAC-CE.

In a second aspect, alone or in combination with the first aspect, process 1000 includes transmitting, to the UE, an indication to adjust a transmit power or a schedule of an uplink communication of the UE based at least in part on a power headroom level value in the MAC-CE.

In a third aspect, alone or in combination with one or more of the first and second aspects, the MAC-CE indicates whether the power headroom level for each panel is for a real panel or a virtual panel.

In a fourth aspect, alone or in combination with one or more of the first through third aspects, process 1000 includes transmitting a value for a triggering condition that includes a threshold for one or more of panel-specific path loss or an MPE level.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a block diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a generation component 1108 and/or a selection component 1110, among other examples.

In some aspects, the apparatus 1100 may be configured to perform one or more operations described herein in connection with FIGS. 1-6. Additionally, or alternatively, the apparatus 1100 may be configured to perform one or more processes described herein, such as process 700 of FIG. 7. In some aspects, the apparatus 1100 and/or one or more components shown in FIG. 11 may include one or more components of the UE described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the UE described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the UE described above in connection with FIG. 2. In some aspects, the transmission component 1104 may be co-located with the reception component 1102 in a transceiver.

The generation component 1108 may generate a MAC-CE that indicates a power headroom level for each panel of multiple panels of the UE, which is configured for multi-panel operation. The transmission component 1104 may transmit the MAC-CE. The selection component 1110 may select the one or more cells and the one or more activated panels.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a block diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a determination component 1208, among other examples.

In some aspects, the apparatus 1200 may be configured to perform one or more operations described herein in connection with FIGS. 1-6. Additionally, or alternatively, the apparatus 1200 may be configured to perform one or more processes described herein, such as process 800 of FIG. 8. In some aspects, the apparatus 1200 and/or one or more components shown in FIG. 12 may include one or more components of the base station described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the base station described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the base station described above in connection with FIG. 2. In some aspects, the transmission component 1204 may be co-located with the reception component 1202 in a transceiver.

The determination component 1208 may determine a configuration for multi-panel power headroom level reporting. The configuration may be based at least in part on a UE capability and/or channel conditions. The transmission component 1204 may transmit, to a UE, a configuration for multi-panel power headroom level reporting. The reception component 1202 may receive a MAC-CE that indicates a power headroom level for each panel of multiple panels of the UE based at least in part on the configuration.

The transmission component 1204 may transmit, to the UE, an indication to adjust a transmit power or a schedule of an uplink communication of the UE based at least in part on one or more power headroom level values in the MAC-CE.

The transmission component 1204 may transmit an indication of the one or more cells and the one or more activated panels to be included in the MAC-CE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a block diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a generation component 1308, among other examples.

In some aspects, the apparatus 1300 may be configured to perform one or more operations described herein in connection with FIGS. 1-6. Additionally, or alternatively, the apparatus 1300 may be configured to perform one or more processes described herein, such as process 900 of FIG. 9. In some aspects, the apparatus 1300 and/or one or more components shown in FIG. 13 may include one or more components of the UE described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the UE described above in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the UE described above in connection with FIG. 2. In some aspects, the transmission component 1304 may be co-located with the reception component 1302 in a transceiver.

The generation component 1308 may generate a MAC-CE that indicates a power headroom level for a single panel among multiple panels of the UE, which is configured for multi-panel operation, based at least in part on a value of a multi-panel indication of a radio resource control parameter being set to indicate single-panel entries for the MAC-CE. The transmission component 1304 may transmit the MAC-CE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a block diagram of an example apparatus 1400 for wireless communication. The apparatus 1400 may be a base station, or a base station may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a determination component 1408, among other examples.

In some aspects, the apparatus 1400 may be configured to perform one or more operations described herein in connection with FIGS. 1-6. Additionally, or alternatively, the apparatus 1400 may be configured to perform one or more processes described herein, such as process 1000 of FIG. 10. In some aspects, the apparatus 1400 and/or one or more components shown in FIG. 14 may include one or more components of the base station described above in connection with FIG. 2. Additionally, or alternatively, one or more components shown in FIG. 14 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1406. In some aspects, the reception component 1402 may include one or more antennas, a demodulator, a MIMO detector, a receive processor, a controller/processor, a memory, or a combination thereof, of the base station described above in connection with FIG. 2.

The transmission component 1404 may transmit communications, such as reference signals, control information, data communications, or a combination thereof, to the apparatus 1406. In some aspects, one or more other components of the apparatus 1406 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modulator, a transmit MIMO processor, a transmit processor, a controller/processor, a memory, or a combination thereof, of the base station described above in connection with FIG. 2. In some aspects, the transmission component 1404 may be co-located with the reception component 1402 in a transceiver.

The determination component 1408 may determine that a UE is to report a single panel, although configured for multi-panel power headroom reporting. The determination component 1408 may generate an indication for single panel reporting. The indication may be based at least in part on a UE capability and/or channel conditions. The transmission component 1404 may transmit, to a UE, an indication that a configuration of the UE for multi-panel reporting of power headroom levels is to be used to report a single panel among multiple panels of the UE. The reception component 1402 may receive a MAC-CE that indicates a power headroom level for the single panel, based at least in part on the indication.

The transmission component 1404 may transmit, to the UE, an indication to adjust a transmit power or a schedule of an uplink communication of the UE based at least in part on a power headroom level value in the MAC-CE. The transmission component 1404 may transmit a value for a triggering condition that includes a threshold for one or more of panel-specific path loss or a maximum permitted exposure level.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

The following provides an overview of some aspects of the present disclosure:

Aspect 1: A method of wireless communication performed by a user equipment (UE), comprising: generating a medium access control control element (MAC-CE) that indicates a power headroom level for each panel of multiple panels of the UE, which is configured for multi-panel operation; and transmitting the MAC-CE.

Aspect 2: The method of aspect 1, wherein the MAC-CE indicates whether the power headroom level for each panel is for a real panel or a virtual panel.

Aspect 3: The method of aspect 1 or 2, wherein an order of entries for the multiple panels in the MAC-CE is based at least in part on one or more of a panel identifier (ID), a sounding reference signal (SRS) resource ID, an SRS resource set, a control resource set pool ID, a closed loop index, a beam group ID, or a transmission configuration indicator state pool ID.

Aspect 4: The method of any of aspects 1-3, wherein the generating of the MAC-CE for multiple panels is based at least in part on a value of a multi-panel indication of a radio resource control parameter indicating multi-panel entries for the MAC-CE.

Aspect 5: The method of any of aspects 1-4, wherein the MAC-CE indicates power headroom levels for a single cell.

Aspect 6: The method of any of aspects 1-5, wherein the MAC-CE indicates a type of signal or a type of channel for the power headroom level.

Aspect 7: The method of any of aspects 1-6, wherein the MAC-CE corresponds to each repetition of a same transport block.

Aspect 8: The method any of aspects 1-7, wherein the MAC-CE indicates power headroom levels for multiple cells and indicates one or more cells and one or more activated panels for which the power headroom levels in the MAC-CE apply.

Aspect 9: The method of aspect 8, wherein the one or more cells and the one or more activated panels are indicated by a base station.

Aspect 10: The method of aspect 8, further comprising selecting the one or more cells and the one or more activated panels.

Aspect 11: A method of wireless communication performed by a base station, comprising: transmitting, to a user equipment (UE), a configuration for multi-panel power headroom level reporting; and receiving a medium access control control element (MAC-CE) that indicates a power headroom level for each panel of multiple panels of the UE based at least in part on the configuration.

Aspect 12: The method of aspect 11, further comprising transmitting, to the UE, an indication to adjust a transmit power or a schedule of an uplink communication of the UE based at least in part on one or more power headroom level values in the MAC-CE.

Aspect 13: The method of aspect 11 or 12, wherein the MAC-CE indicates whether the power headroom level for each panel is for a real panel or a virtual panel.

Aspect 14: The method of any of aspects 11-13, wherein an order of entries for the multiple panels in the MAC-CE is based at least in part on one or more of a panel identifier (ID), a sounding reference signal (SRS) resource ID, an SRS resource set, a control resource set pool ID, a closed loop index, a beam group ID, or a transmission configuration indicator state pool ID.

Aspect 15: The method of any of aspects 11-14, wherein the MAC-CE indicates power headroom levels for a single cell.

Aspect 16: The method of any of aspects 11-15, wherein the MAC-CE indicates a type of signal or a type of channel for the power headroom level.

Aspect 17: The method of any of aspects 11-16, wherein the MAC-CE corresponds to each repetition of a same transport block.

Aspect 18: The method of any of aspects 11-17, wherein the MAC-CE indicates power headroom levels for multiple cells and indicates one or more cells and one or more activated panels for which power headroom levels in the MAC-CE apply.

Aspect 19: The method of aspect 18, further comprising transmitting an indication of the one or more cells and the one or more activated panels to be included in the MAC-CE.

Aspect 20: A method of wireless communication performed by a user equipment (UE), comprising: generating a medium access control control element (MAC-CE) that indicates a power headroom level for a single panel among multiple panels of the UE, which is configured for multi-panel operation, based at least in part on a value of a multi-panel indication of a radio resource control parameter being set to indicate single-panel entries for the MAC-CE; and transmitting the MAC-CE.

Aspect 21: The method of aspect 20, wherein the MAC-CE indicates whether the power headroom level for each panel is for a real panel or a virtual panel.

Aspect 22: The method of aspect 20 or 21, wherein the generating of the MAC-CE for multiple panels is based at least in part on satisfaction of a triggering condition that includes one or more of panel-specific path loss or a change in a maximum permitted exposure level.

Aspect 23: A method of wireless communication performed by a base station, comprising: transmitting, to a user equipment (UE), an indication that a configuration of the UE for multi-panel reporting of power headroom levels is to be used to report a single panel among multiple panels of the UE; and receiving a medium access control control element (MAC-CE) that indicates a power headroom level for the single panel, based at least in part on the indication.

Aspect 24: The method of aspect 23, wherein the indication includes a value of a multi-panel indication of a radio resource control parameter that is set to indicate single-panel entries for the MAC-CE.

Aspect 25: The method of aspect 23 or 24, further comprising transmitting, to the UE, an indication to adjust a transmit power or a schedule of an uplink communication of the UE based at least in part on a power headroom level value in the MAC-CE.

Aspect 26: The method of any of aspects 23-25, wherein the MAC-CE indicates whether the power headroom level for each panel is for a real panel or a virtual panel.

Aspect 27: The method of any of aspects 23-26, further comprising transmitting a value for a triggering condition that includes a threshold for one or more of panel-specific path loss or a maximum permitted exposure level.

Aspect 28: An apparatus for wireless communication at a device, comprising a processor; memory coupled with the processor; and instructions stored in the memory and executable by the processor to cause the apparatus to perform the method of one or more aspects of aspects 1-27.

Aspect 29: A device for wireless communication, comprising a memory and one or more processors coupled to the memory, the memory and the one or more processors configured to perform the method of one or more aspects of aspects 1-27.

Aspect 30: An apparatus for wireless communication, comprising at least one means for performing the method of one or more aspects of aspects 1-27.

Aspect 31: A non-transitory computer-readable medium storing code for wireless communication, the code comprising instructions executable by a processor to perform the method of one or more aspects of aspects 1-27.

Aspect 32: A non-transitory computer-readable medium storing a set of instructions for wireless communication, the set of instructions comprising one or more instructions that, when executed by one or more processors of a device, cause the device to perform the method of one or more aspects of aspects 1-27.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors operatively coupled to the memory, the memory and the one or more processors configured to:
generate a medium access control control element (MAC-CE) that indicates a power headroom level for each panel of multiple panels of the UE, which is configured for multi-panel operation; and
transmit the MAC-CE.

2. The UE of claim 1, wherein the MAC-CE indicates whether the power headroom level for each panel is for a real panel or a virtual panel.

3. The UE of claim 1, wherein an order of entries for the multiple panels in the MAC-CE is based at least in part on one or more of a panel identifier (ID), a sounding reference signal (SRS) resource ID, an SRS resource set, a control resource set pool ID, a closed loop index, a beam group ID, or a transmission configuration indicator state pool ID.

4. The UE of claim 1, wherein the generating of the MAC-CE for multiple panels is based at least in part on a value of a multi-panel indication of a radio resource control parameter indicating multi-panel entries for the MAC-CE.

5. The UE of claim 1, wherein the MAC-CE indicates power headroom levels for a single cell.

6. The UE of claim 1, wherein the MAC-CE indicates a type of signal or a type of channel for the power headroom level.

7. The UE of claim 1, wherein the MAC-CE corresponds to each repetition of a same transport block.

8. The UE of claim 1, wherein the MAC-CE indicates power headroom levels for multiple cells and indicates one or more cells and one or more activated panels for which the power headroom levels in the MAC-CE apply.

9. The UE of claim 8, wherein the one or more cells and the one or more activated panels are indicated by a base station.

10. The UE of claim 8, wherein the one or more processors are further configured to select the one or more cells and the one or more activated panels.

11. A base station for wireless communication, comprising:
a memory; and
one or more processors operatively coupled to the memory, the memory and the one or more processors configured to:
transmit, to a user equipment (UE), a configuration for multi-panel power headroom level reporting; and
receive a medium access control control element (MAC-CE) that indicates a power headroom level for each panel of multiple panels of the UE based at least in part on the configuration.

12. The base station of claim 11, wherein the one or more processors are further configured to transmit, to the UE, an indication to adjust a transmit power or a schedule of an uplink communication of the UE based at least in part on one or more power headroom level values in the MAC-CE.

13. The base station of claim 11, wherein the MAC-CE indicates whether the power headroom level for each panel is for a real panel or a virtual panel.

14. The base station of claim 11, wherein an order of entries for the multiple panels in the MAC-CE is based at least in part on one or more of a panel identifier (ID), a sounding reference signal (SRS) resource ID, an SRS resource set, a control resource set pool ID, a closed loop index, a beam group ID, or a transmission configuration indicator state pool ID.

15. The base station of claim 11, wherein the MAC-CE indicates power headroom levels for a single cell.

16. The base station of claim 11, wherein the MAC-CE indicates a type of signal or a type of channel for the power headroom level.

17. The base station of claim 11, wherein the MAC-CE corresponds to each repetition of a same transport block.

18. The base station of claim 11, wherein the MAC-CE indicates power headroom levels for multiple cells and indicates one or more cells and one or more activated panels for which power headroom levels in the MAC-CE apply.

19. The base station of claim 18, wherein the one or more processors are further configured to transmit an indication of the one or more cells and the one or more activated panels to be included in the MAC-CE.

20. A user equipment (UE) for wireless communication, comprising:
a memory; and
one or more processors operatively coupled to the memory, the memory and the one or more processors configured to:
generate a medium access control control element (MAC-CE) that indicates a power headroom level for a single panel among multiple panels of the UE, which is configured for multi-panel operation, based at least in part on a value of a multi-panel indication of a radio resource control parameter being set to indicate single-panel entries for the MAC-CE; and
transmit the MAC-CE.

21. The UE of claim 20, wherein the MAC-CE indicates whether the power headroom level for each panel is for a real panel or a virtual panel.

22. The UE of claim 20, wherein the generating of the MAC-CE for multiple panels is based at least in part on satisfaction of a triggering condition that includes one or more of panel-specific path loss or a change in a maximum permitted exposure level.

23. A base station for wireless communication, comprising:
a memory; and
one or more processors operatively coupled to the memory, the memory and the one or more processors configured to:
transmit, to a user equipment (UE), an indication that a configuration of the UE for multi-panel reporting of power headroom levels is to be used to report a single panel among multiple panels of the UE; and
receive a medium access control control element (MAC-CE) that indicates a power headroom level for the single panel, based at least in part on the indication.

24. The base station of claim 23, wherein the indication includes a value of a multi-panel indication of a radio resource control parameter that is set to indicate single-panel entries for the MAC-CE.

25. The base station of claim 23, wherein the one or more processors are further configured to transmit, to the UE, an indication to adjust a transmit power or a schedule of an uplink communication of the UE based at least in part on a power headroom level value in the MAC-CE.

26. The base station of claim 23, wherein the MAC-CE indicates whether the power headroom level for each panel is for a real panel or a virtual panel.

27. The base station of claim 23, wherein the one or more processors are further configured to transmit a value for a triggering condition that includes a threshold for one or more of panel-specific path loss or a maximum permitted exposure level.
